(19) United States
(12) Patent Application Publication
(10) Pub. No.: US 2014/0289307 A1
(43) Pub. Date: Sep. 25, 2014

(54) METHOD FOR TRANSMITTING DATA BETWEEN ELECTRONIC DEVICES

(71) Applicant: HON HAI PRECISION INDUSTRY CO., LTD., New Taipei (TW)

(72) Inventors: CHUNG-I LEE, New Taipei (TW); CHIEN-FA YEH, New Taipei (TW); YU-FENG CHIEN, New Taipei (TW); GUO-HAO HUANG, New Taipei (TW)

(21) Appl. No.: 13/945,908

(22) Filed: Jul. 19, 2013

(30) Foreign Application Priority Data
Mar. 20, 2013 (TW) 102109940

(51) Int. Cl. H04L 29/06

(52) U.S. Cl. CPC H04L 67/42
USPC 709/203

(57) ABSTRACT

A method provides fast data transmission between electronic devices, and avoids network congestion. A number of electronic devices in a network are divided into a client group including client devices and a server group including service devices. A control device for each client device is appointed from among the service devices according to a connection quality between the client device and the service device, and a route path between every two service devices is determined according to a connection quality between every two service devices. A route table of each service device is created according to the route path between every two service devices, and requested data is transmitted from a target device to a request device according to the route path.

### BACKGROUND

1. Technical Field

Embodiments of the present disclosure relate to a method for transmitting data between electronic devices.

2. Description of Related Art

In a video conference between a plurality of networked electronic devices, video data transmitted between the electronic devices may be delayed or lost due to network congestion. Generally, two connection methods between the electronic devices in the video conference are used. In the first method, the electronic devices are connected in a point-to-point (P2P) architecture. And in the second method, the electronic devices are connected in a slave/master architecture (one electronic device is selected to be a master device). In the first method, network congestion may occur when a lot of electronic devices are connected to the network. In the second method, the master device cannot process the data transmission requests within an acceptable time when a lot of slave devices request the video data simultaneously. Therefore, a more efficient method for transmitting data between electronic devices is desired.

### BRIEF DESCRIPTION OF THE DRAWINGS

FIG. 1 is a flowchart of a method for transmitting data between electronic devices.

FIG. 2 is an schematic diagram of a plurality of electronic devices in a specified network.

FIG. 3 is an schematic diagram of dividing between the electronic devices in a specified network into a client group and a server group.

FIG. 4 is an schematic diagram of determining route paths of each service device in the server group.

FIG. 5 is an schematic diagram of route tables of the service devices.

### DETAILED DESCRIPTION

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other storage medium.

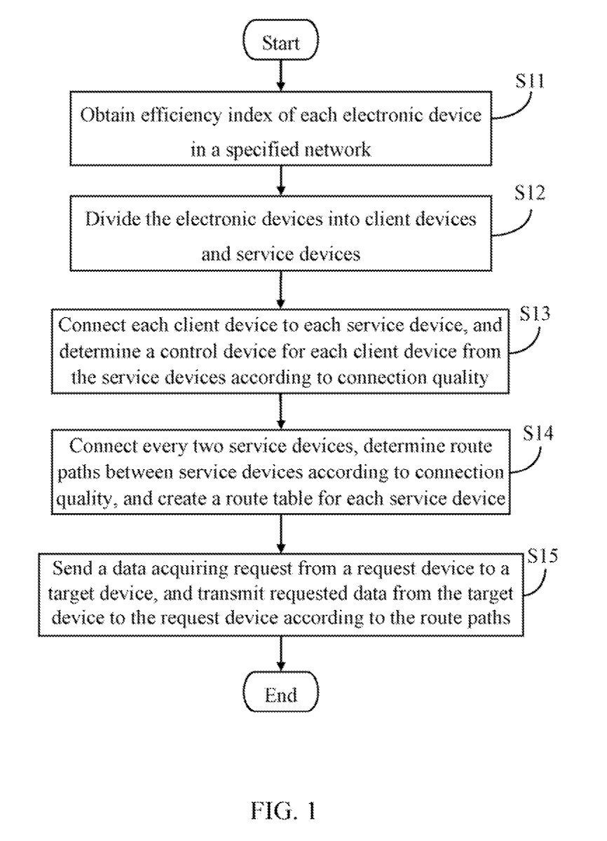

FIG. 1 is a flowchart of a method for transmitting data between electronic devices. Depending on the embodiment, additional steps may be added, others removed, and the ordering of the steps may be changed. In this embodiment, the transmitted data may be video data transmitted between the electronic devices in a specified network utilized for a video conference. The specified network may be an intranet, the Internet or other suitable communication network, such as a general packet radio service (GPRS) network. In other embodiments, the transmitted data may be information of virtual machines installed in the electronic device.

In step S11, when one electronic device in the specified network sends out a conference connection request, the electronic device obtains an efficiency index (or called performance index) of each electronic device in the specified network. The efficiency index includes, but is not limited to, a central processing unit (CPU) speed index (hereinafter referred to as “CPU index”), a memory capacity index (hereinafter referred to as “memory index”), and a network bandwidth index. Different items of hardware have different weights in the efficiency index. For example, the efficiency index of the CPU of a type of “INTEL®-i7” is given a score of 700, the efficiency index of the CPU of a type of “INTEL®-i5” is 500, and the efficiency index of the CPU of a type of “INTEL®-i3” is 300. The efficiency index of the memory of a type of double data rate (DDR) 16 GB is 80, the efficiency index of the memory of a type of DDR 8 GB is 40, and the efficiency index of the memory of a type of DDR 4 GB is 20. The efficiency index of the network bandwidth of a 100 MB/second type is 200, the efficiency index of the network bandwidth of a 50 MB/second type is 100, and efficiency index of the network bandwidth of a 20 MB/second type is 40. In one embodiment, the efficiency index of the electronic device is obtained by calculating a sum of the efficiency indexes of the specified types of hardware (e.g., the CPU and the network bandwidth) of the electronic device.

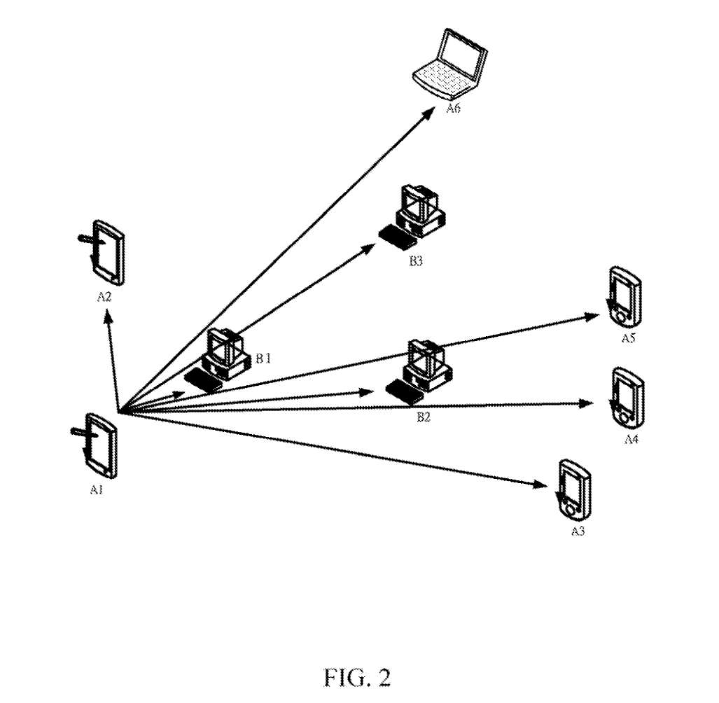

As shown in FIG. 2, when the electronic device “A1” sends out a conference connection request and the other electronic devices (e.g., “A2˜A6”, “B1˜B3”) of the conference parties accept the conference connection request, the efficiency indexes of the other electronic devices are sent to the electronic device “A1”.

In the embodiment, the electronic device includes a display device, an input device, a storage device, and at least one processor. The electronic device may be a computer, a smart phone or a personal digital assistant (PDA). The display device may display video data in the video conference, and the input device may be a mouse or a keyboard used for input. The storage device may be a non-volatile computer storage chip that can be electrically erased and reprogrammed, such as a hard disk or a flash memory card.

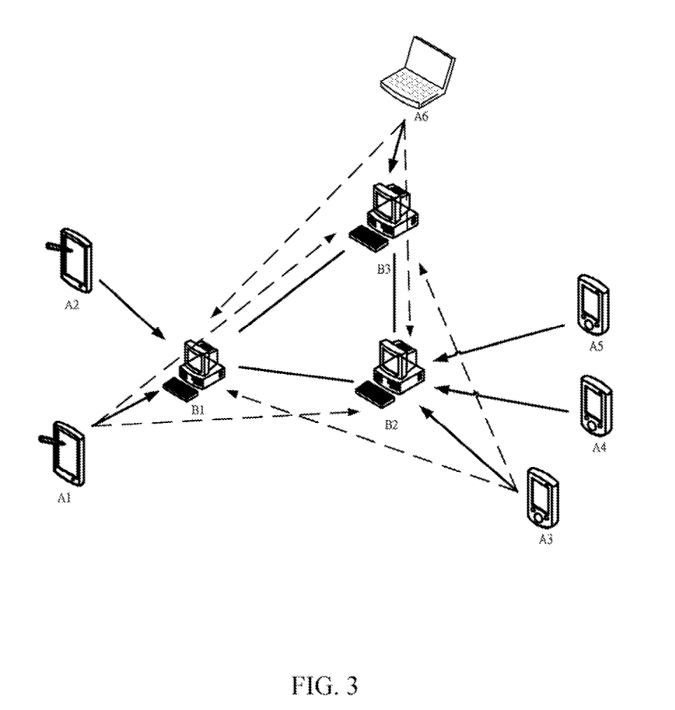

In step S12, the electronic device “A1” divides the electronic devices in the specified network into a client group as client devices and a server group as service devices, according to the efficiency index of each electronic device in the specified network. An address (e.g., an IP address) of each electronic device is recorded, and a grouped result is sent to each electronic device in the specified network. For example, as shown in FIG. 2, the electronic devices “A1˜A6” which have lower efficiency index (e.g., less than a preset value 1000) are grouped in the client group (hereinafter referred to as client devices “A1˜A6”), and the electronic devices “B1˜B3” which have higher efficiency index (e.g., greater than or equal to 1000) are grouped in the server group (hereinafter referred to as service devices “B1˜B3”). In this embodiment, the service devices “B1˜B3” are used as routing devices to transmit video data from a request device (e.g., the client device “A1”) to a target device (e.g., the client device “A2”). For example, as shown in FIG. 3, the video data transmitted from the client device “A1” to the client device “A2” is first transmitted to the service device “B1”, then the video data is transmitted from the service device “B1” to the client device “A2.”

In another embodiment, the client group and the server group may be determined according to other methods. For example, handheld devices may be grouped together in the client group, and the desktop computers are grouped together in the server group. The client group and the server group may be determined according to a type of operating system installed in each electronic device. For example, the electronic devices with a LINUX® operating system or a UNIX® operating system may be grouped together in the server group, and the non-LINUX® and non-UNIX® electronic devices may be grouped together in the client group.

In step S13, each client device (e.g., A1˜A6) in the client group connects to each service device (e.g., B1˜B3) in the server group, and one of the service devices in the server group is determined and appointed as a control device for each client device according to a connection quality between the client device and each of the service devices. A feedback time delay of a connection (hereinafter referred to as “connection feedback time”) between the client device and each of the service devices is taken as the indication of connection quality. A short connection feedback time represents a good connection quality. In this embodiment, the control device of the client device is the service device having the shortest connection feedback time. For example, as shown in FIG. 3, the service device “B1” thus controls the client device “A1” and “A2”, and the service device “B2” thus controls the client device “A3”, “A4”, and “A5”, and the service device “B3” thus controls the client device “A6”.

In another embodiment, the connection quality may be determined using other methods. For example, the connection quality may be indicated according to a physical distance between the client device and the service device, where a short physical distance represents a good connection quality. That is, the control device of the client device is the service device having the shortest physical distance.

In step S14, the service devices are connected to each other, to determine a route path (or called routing path) between every two service devices according to a connection quality between the every two service devices, and create a route table (or called routing path) for each service device according to the route path between every two service devices. The connection quality may be determined according to a connection feedback time between every two service devices. A short connection feedback time represents a good connection quality. In this embodiment, a route path between every two service devices is a routing connection having a shortest connection feedback time.

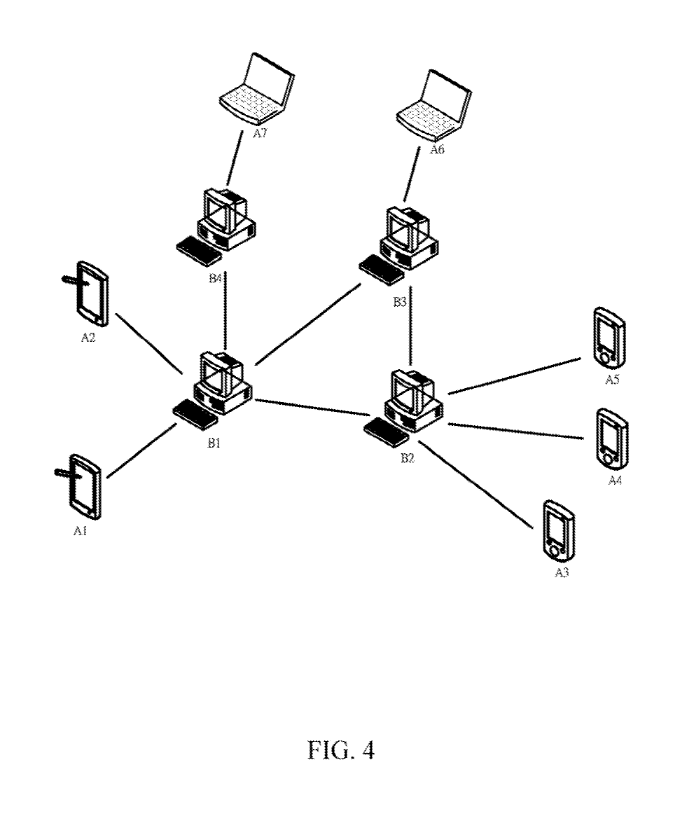

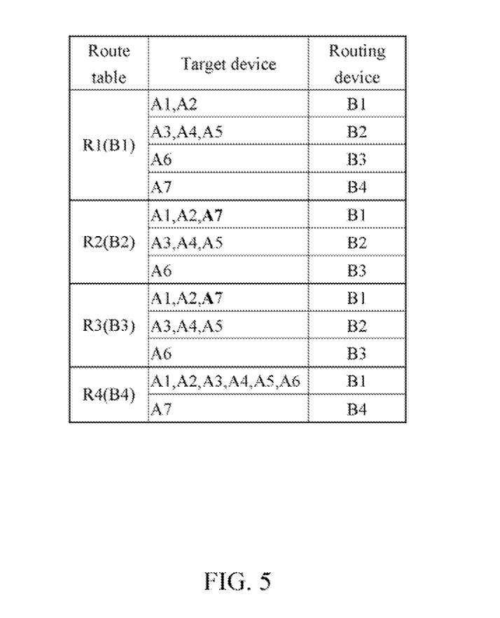

For example, referring to FIG. 4, if the connection feedback time of a routing connection of B2->B4 (B2 is directly connected to B4) is greater than the connection feedback time of a routing connection of B2->B1->B4 (B2 is connected to B4 through “B1”), and the connection feedback time of a routing connection of B2->B3->B4 (B2 is connected to B4 through “B3”) is greater than the connection feedback time of the routing connection of B2->B1->B4. That is, the routing connection of B2->B1->B4 has the shorter connection feedback time, thus the route path between the service devices “B2” and “B4” is determined as “B2->B1->B4”. When the video data needs to be transmitted from “B2” to “B4”, the video data is firstly transmitted to “B1”, and further transmitted from “B1” to “B4”. When the video data needs to be transmitted from “B4” to “B2”, the video data is also firstly transmitted to “B1”, and further transmitted from “B1” to “B2”. A route table of each service device (referring to FIG. 5) is created based on the route path between every two service devices of FIG. 4. For example, as shown in FIG. 5, “R1” represents the route table of the service device “B1”, “R2” represents the route table of the service device “B2”, “R3” represents the route table of the service device “B3”, and “R4” represents the route table of the service device “B4.”

As shown in FIG. 5, a route table of a service device records a plurality of routing devices between the service device and a plurality of target devices. The target devices are the client devices or the service devices which send out the video data to a request device (or called requesting device). The routing devices are the service devices in the server group. For example, as shown in FIG. 4, if the client device “A1” sends a data acquiring request to the client device “A2”, and the client device “A2” is the target device, the service device “B1” is the routing device.

In another embodiment, the route path between every two service devices may be determined using other methods. For example, the route path between two every service devices is created by connecting every two service devices in the server group using a point-to point (P2P) method. In another embodiment, the route path between every two service devices may be determined according to the efficiency index of each service device in the server group. The service device having a higher efficiency index is determined as the routing device in the route path. For example, if the efficiency index of the service device “B4” is less than the efficiency index of the service device “B1”, the video data transmitted to the service device “B4” is firstly transmitted to the service device “B1.”

In step S15, when a data acquiring request is sent from a request device (e.g. the client device “A3”) to a target device (e.g., the client device “A7”), the target device transmits requested data (e.g., video data) to the request device according to the route paths in the route tables. For example, the request device is the electronic device which wants to acquire the video data, and the target device is the electronic device which sends out the video data.

If the request device is the client device in the client group, the target device first determines a control device of the request device from the service devices of the server group, and the target device transmits the requested data (e.g., current video data of the target device) to the request device according to the route paths in the route table of the determined control device. If the request device is the service device in the server group, the target device transmits the requested data to the request device according to the route paths in the route table of the request device.

For example, referring to FIG. 4, when the request device “A3” sends an image acquiring request to the target device “A7”, a control device of the request device “A3” is determined as being the service device “B2”. Looking up the route table “R2” of the service device “B2,” as shown in FIG. 5, the data transmitted from the target device

“A7” is passed to the routing device “B1” (i.e., the service device “B1”). Furthermore, the route table “R1” of the routing device “B1” shows that the data transmitted by the target device “A7” is further passed to the routing device “B4” (i.e., the service device “B4”). Because the routing device “B4” is the control device of the target device “A7”, the recursion process is ended. Thus, a transmission path of the requested data from the target device “A7” to the request device “A3” is as follows: A7->B4->B1->B2->A3.

In FIG. 5 of this embodiment, the target devices of each route table merely include the client devices in the client group. In other embodiments, the service devices in the server group may be added to the target devices of each route table using the same method.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A method for transmitting data between electronic devices in a specified network, the method comprising:
dividing the electronic devices into a client group as client devices and a server group as service devices;
connecting each of the client devices in the client group to each of the service devices in the server group, and determining a control device for each of the client devices from the service devices according to a connection quality between each of the client devices and one of the service devices;
connecting every two service devices in the server group, determining a route path between every two of the service devices according to a connection quality between every two service devices, and creating a route table for each of the service devices according to the route paths between the service device and each of the other service devices; and
sending a data acquiring request from a request device of the electronic devices in the specified network to a target device of the electronic devices in the specified network, and transmitting requested data from the target device to the request device according to the route paths in the route tables.

2. The method according to claim 1, wherein the electronic devices are grouped in the client group or the server group according to an efficiency index of each of the electronic devices, the electronic devices having lower efficiency index are grouped in the client group, and the electronic devices having higher efficiency index are grouped in the server group.

3. The method according to claim 2, wherein the efficiency index comprises a central processing unit (CPU) index, a memory index, and a network bandwidth index.

4. The method according to claim 3, wherein the electronic devices are grouped in the client group or the server group according to a type of each of the electronic device or a type of an operating system installed in each of the electronic devices.

5. The method according to claim 1, wherein the connection quality between each of the client devices and one of the service devices is determined by a connection feedback time between each of the client devices and the service device.

6. The method according to claim 5, wherein the control device of the client device is one of the service devices having a shortest connection feedback time.

7. The method according to claim 1, wherein the connection quality between each of the client devices and one of the service devices is determined by a physical distance between each of the client devices and the service device.

8. The method according to claim 7, wherein the control device of the client device is one of the service devices having a shortest physical distance.

9. The method according to claim 1, wherein the connection quality between every two service devices is determined by a connection feedback time between every two service devices.

10. The method according to claim 9, wherein the route path between every two of the service devices is a routing connection having a shortest connection feedback time.

11. The method according to claim 1, wherein the route table of each of the service devices records a plurality of routing devices between the service device and a plurality of target devices.

12. The method according to claim 11, wherein the step of transmitting requested data from the target device to the request device according to the route paths in the route tables comprises:
determining a control device for the request device from the service devices in the server group by the target device when the request device is one of the client devices in the client group, and transmitting the requested data from the target device to the request device according to the route paths in the route table of the determined control device; or
transmitting the requested data from the target device to the request device according to the route paths in the route table of the request device when the request device is one of the service devices in the server group.
